(19) United States
(12) Patent Application Publication
(10) Pub. No.: US 2026/0303238 A1
(43) Pub. Date: Oct. 1, 2026

(54) METHODS, COMMUNICATIONS DEVICES, INFRASTRUCTURE EQUIPMENT AND SYSTEMS

(71) Applicant: Sony Group Corporation, Tokyo (JP)

(72) Inventors: Shin Horng WONG, Basingstoke (GB); Yassin Aden AWAD, Basingstoke (GB)

(73) Assignee: Sony Group Corporation, Tokyo (JP)

(21) Appl. No.: 18/880,290

(22) PCT Filed: Jul. 6, 2023
(86) PCT No.: PCT/EP2023/068698

§ 371 Date: Dec. 31, 2024

(30) Foreign Application Priority Data
Jul. 13, 2022 (EP) 22184826.0

(51) Int. Cl. H04B 17/309; H04L 1/00; H04W 52/36

(52) U.S. Cl. CPC H04B 17/346; H04L 1/0003; H04W 52/367

(57) ABSTRACT

A method for controlling cross-link interference (CLI) in a wireless communications network is disclosed. The method involves detecting a CLI priority indicator from other network infrastructure, which indicates their CLI priority level. Based on this, the method determines whether a wireless transmission should occur between the infrastructure equipment and a device within its coverage area. By comparing the CLI priority levels, the method identifies the necessary modifications to transmission parameters to reduce interference with other infrastructure equipment. The transmission parameters are then adjusted accordingly to mitigate the interference.

### BACKGROUND

### Field of Disclosure

The present disclosure relates to infrastructure equipment of a wireless communications network, communications devices, systems and methods of operating infrastructure equipment of a wireless communications network and communications devices to control cross link interference, CLI. The present disclosure claims the Paris convention priority of European patent application number EP 22184826.0 filed on 13 Jul. 2022, the contents of which are incorporated herein by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Modern mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Wireless communications networks are expected to routinely and efficiently support communications with an ever-increasing range of devices associated with a wide range of data traffic profiles and types. For example, it is expected that wireless communications networks efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is a desire for current generation wireless communications networks, for example those referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems. 5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Embodiments can provide a method of controlling cross-link interference, CLI, by infrastructure equipment of a wireless communications network. The method comprises detecting a CLI priority indicator from other infrastructure equipment of the wireless communications network. The CLI priority indicator comprises an indication of a CLI priority level of the other infrastructure equipment. The method comprises determining that a wireless transmission is to be communicated between the infrastructure equipment and a communications device in a coverage area provided by the infrastructure equipment The method comprises determining, based on a comparison of a CLI priority level of the infrastructure equipment and the CLI priority level of the other infrastructure equipment indicated by the CLI priority indicator, an extent to which one or more transmission parameters of the wireless transmission should be modified to reduce interference caused by the wireless transmission at the other infrastructure equipment. The method comprises modifying the one or more transmission parameters of the wireless transmission in accordance with the determined extent of modification.

Embodiments can provide improvements to CLI control in wireless communications networks. For example, as will be appreciated from an understanding of the detailed description below, embodiments can provide CLI control methods which take into account the relative importance of interfering transmissions.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically illustrates an example of inter-cell cross link interference.

FIG. 5 illustrates an example approach for accounting for inter-cell cross link interference.

FIG. 6 illustrates an example of atmospheric ducting and remote interference.

FIG. 7 illustrates the slot alignments in the example of remote interference according to FIG. 6.

FIG. 8 illustrates a process for mitigating the effects of remote interference.

FIG. 9 schematically illustrates an example of intra-cell cross link interference

FIG. 10 illustrates an example division of system bandwidth into dedicated uplink and downlink sub-bands.

FIG. 11 illustrates an example of transmission power leakage.

FIG. 12 illustrates an example of receiver power selectivity.

FIG. 13 illustrates an example of inter sub-band interference.

FIG. 14 illustrates an example of intra sub-band interference.

FIG. 15 schematically illustrates inter-sub band CLI where two gNBs are both victims and aggressors.

FIG. 16 is a flow diagram illustrating a method of controlling CLI by infrastructure equipment of a wireless communications network in accordance with example embodiments.

FIG. 17 schematically illustrates using Priority-RS to indicate a CLI priority levels for two gNBs in accordance with example embodiments.

FIG. 18 schematically illustrates a bitmap of a CLI priority indicator transmitted using PDCCH in accordance with example embodiments.

### DETAILED DESCRIPTION OF THE EMBODIMENTS

### Long Term Evolution Advanced Radio Access Technology (4G)

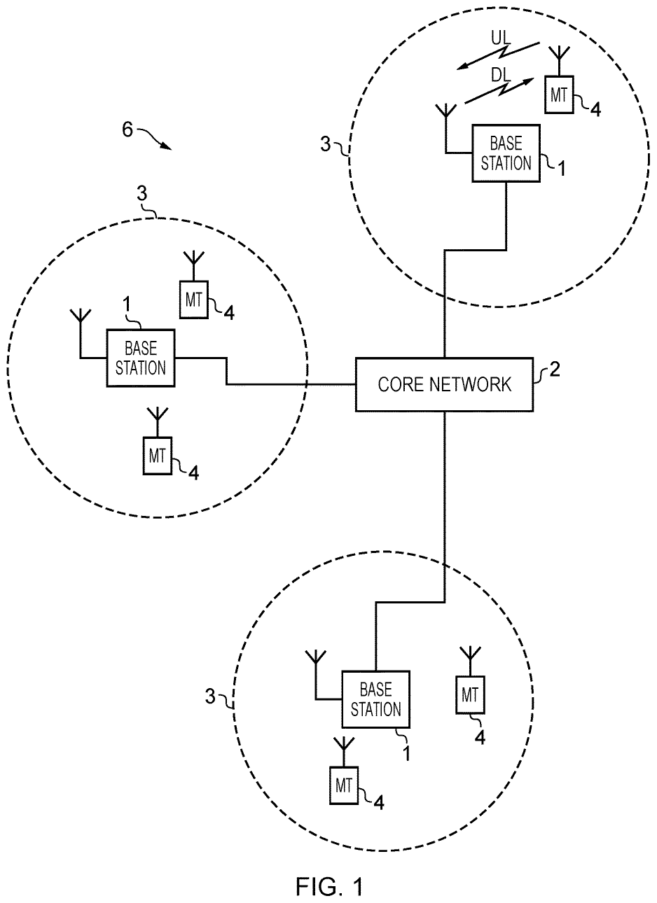

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP(®) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices or mobile terminals (MT) 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. The communications or terminal devices 4 may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality.

However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G (NR))

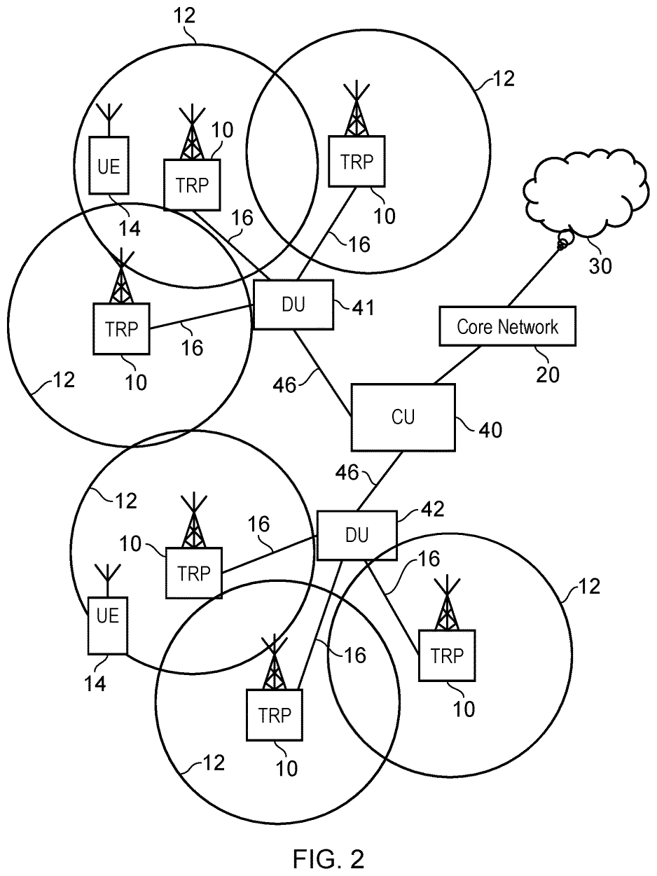

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

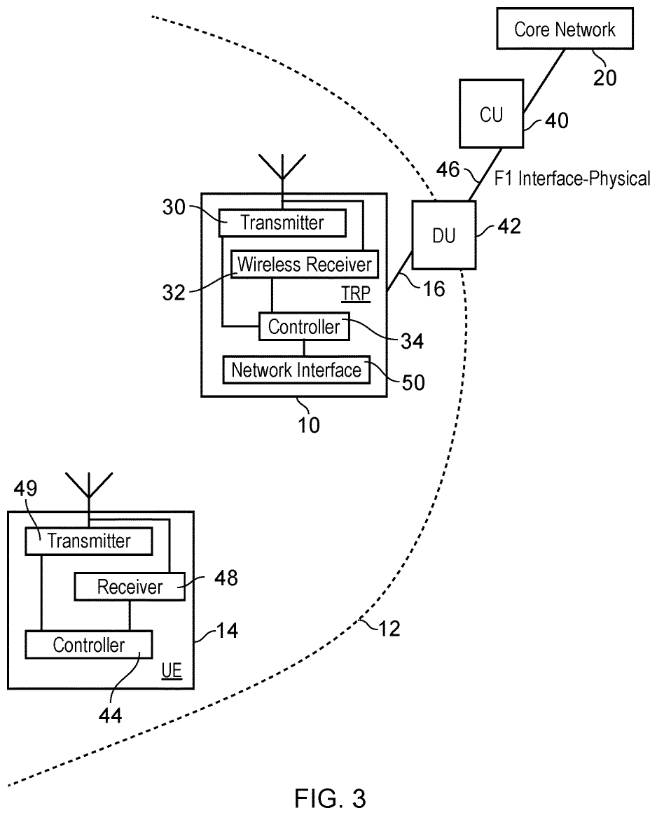

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter circuit 49, a receiver circuit 48 and a controller circuit 44 which is configured to control the transmitter circuit 49 and the receiver circuit 48 to transmit signals representing uplink data to the wireless communications network via the wireless access interface formed by the TRP 10 and to receive downlink data as signals transmitted by the transmitter circuit 30 and received by the receiver circuit 48 in accordance with the conventional operation.

The transmitter circuits 30, 49 and the receiver circuits 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controller circuits 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Full Duplex Time Division Duplex (FD-TDD)

NR/5G networks can operate using Time Division Duplex (TDD), where an entire frequency band or carrier is switched to either downlink or uplink transmissions for a time period and can be switched to the other of downlink or uplink transmissions at a later time period. Currently, TDD operates in Half Duplex mode (HD-TDD) where the gNB or UE can, at a given time, either transmit or receive packets, but not both at the same time. As wireless networks transition from NR to 5G-Advanced networks, a proposed new feature of such networks is to enhance duplexing operation for Time Division Multiplexing (TDD) by enabling Full Duplex operation in TDD (FD-TDD) [2]. In FD-TDD, a gNB can transmit and receive data to and from the UEs at the same time on the same frequency band or carrier. In addition, a UE can operate either in HD-TDD or FD-TDD mode, depending on its capability. For example, when UEs are only capable of supporting HD-TDD, FD-TDD is achieved at the gNB by scheduling a DL transmission to a first UE and scheduling an UL transmission from a second UE within the same orthogonal frequency division multiplexing (OFDM) symbol (i.e. at the same time). Conversely, when UEs are capable of supporting FD-TDD, FD-TDD is achieved both at the gNB and the UE, where the gNB can simultaneously schedule this UE with DL and UL transmissions within the same OFDM symbol by scheduling the DL and UL transmissions at different frequencies (e.g. physical resource blocks (PRBs)) of the system bandwidth. A UE supporting FD-TDD requires more complex hardware than a UE that only supports HD-TDD. Development of current 5G networks is focused primarily on enabling FD-TDD at the gNB with UEs operating in HD-TDD mode.

Motivations for enhancing duplexing operation for TDD include an improvement in system capacity, reduced latency, and improved uplink coverage. For example, in current HD-TDD systems, OFDM symbols are allocated only for either a DL or UL direction in a semi-static manner. Hence, if one direction experiences less or no data, the spare resources cannot be used in the other direction, or are, at best, under-utilized. However, if resources can be used for DL data and UL data (as in FD-TDD) at the same time, the resource utilization in the system can be improved. Furthermore, in current HD-TDD systems, a UE can receive DL data, but cannot transmit UL data at the same time, which causes delays. If a gNB or UE is allowed to transmit and receive data at the same time (as with FD-TDD), the traffic latency will be improved. In addition, UEs are usually limited in the UL transmissions when located close to the edge of a cell. While the UE coverage at the cell-edge can be improved if more time domain resources are assigned to UL transmissions (e.g. repetitions), if the UL direction is assigned more time resources, fewer time resources can be assigned to the DL direction, which can lead to system imbalance. Enabling FD-TDD would help allow a UE to be assigned more UL time resources when required, without sacrificing DL time resources.

### Inter-Cell Cross Link Interference (CLI)

In NR systems, a slot format (i.e. the allocation of DL and UL OFDM symbols in a slot) can be semi-statically or dynamically configured, where each OFDM symbol (OS) in a slot can be configured as Downlink (DL), Uplink (UL) or Flexible (F). An OFDM symbol that is semi-statically configured to be Flexible can be indicated dynamically as DL, UL or remain as Flexible by a Dynamic Slot Format Indicator (SFI), which is transmitted in a Group Common (GC) DCI using DCI Format 2_0, where the CRC of the GC-DCI is masked with SFI-RNTI. Flexible OFDM Symbols that remain Flexible after instruction from the SFI can be changed to a DL symbol or an UL symbol by a DL Grant or an UL Grant respectively. That is, a DL Grant scheduling a PDSCH that overlaps Flexible OFDM Symbols would convert these Flexible OFDM Symbols to DL and similarly an UL Grant scheduling a PUSCH that overlaps Flexible OFDM Symbols would convert these Flexible OFDM Symbols to UL.

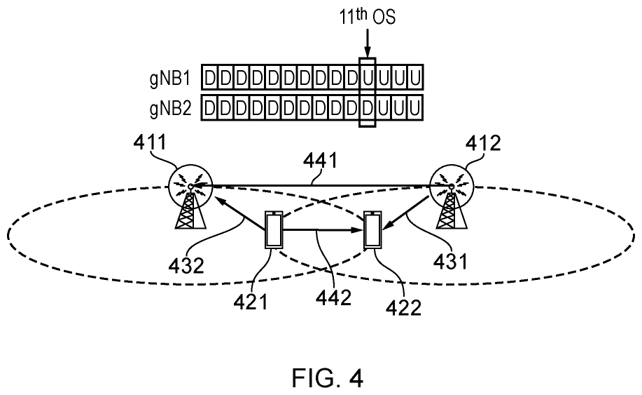

Since each gNB in a network can independently change the configuration of each OFDM symbol, either semi-statically or dynamically, it is possible that in a particular OFDM symbol, one gNB is configured for UL and a neighbour gNB is configured for DL. This causes inter-cell Cross Link Interference (CLI) among the conflicting gNBs. Inter-cell CLI occurs when a UE's UL transmission interferes with a DL reception by another UE in another cell, or when a gNB's DL transmission interferes with an UL reception by another gNB. That is, inter-cell CLI is caused by non-aligned (conflicting) slot formats among neighbouring cells. An example is shown in FIG. 4, where gNB1 411 and gNB2 412 have synchronised slots. At a given slot, gNB1's 411 slot format={D, D, D, D, D, D, D, D, D, D, U, U, U, U} whilst gNB2's 412 slot format={D, D, D, D, D, D, D, D, D, D, D, U, U, U}, where ‘D’ indicates DL and ‘U’ indicates UL. Inter-cell CLI occurs during the 11th OFDM symbol of the slot, where gNB1 411 is performing UL whilst gNB2 412 is performing DL. Specifically, inter-cell CLI 441 occurs between gNB1 411 & gNB2 412, where gNB2's 412 DL transmission 431 interferes with gNB1's 411 UL reception 432. CLI 442 also occurs between UE1 421 & UE2 422, where UE1's 421 UL transmission 432 interferes with UE2's 422 DL reception 431.

Some legacy implementations attempt to reduce inter-cell CLI in TDD networks caused by flexible and dynamic slot format configurations. Two CLI measurement reports to manage and coordinate the scheduling among neighbouring gNBs include: sounding reference signal (SRS) reference signal received power (RSRP) and CLI received signal strength indicator (RSSI). In SRS-RSRP, a linear average of the power contribution of an SRS transmitted by a UE is measured by a UE in a neighbour cell. This is measured over the configured resource elements within the considered measurement frequency bandwidth, in the time resources in the configured measurement occasions. In CLI-RSSI, a linear average of the total received power observed is measured only at certain OFDM symbols of the measurement time resource(s), in the measurement bandwidth, over the configured resource elements for measurement by a UE.

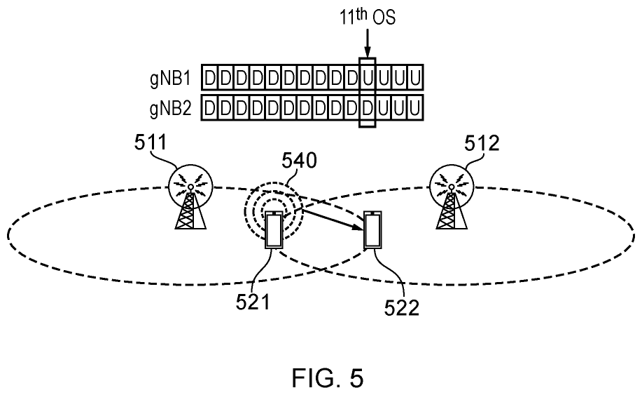

Both SRS-RSRP and CLI-RSSI are RRC measurements and are performed by a UE, for use in mitigating against UE to UE inter-cell CLI. For SRS-RSRP, an aggressor UE (i.e. a UE whose UL transmissions cause interference at another UE in a neighbouring cell) would transmit an SRS in the uplink and a victim UE (i.e. a UE that experiences interference due to an UL transmission from the UE in the neighbouring cell) in a neighbour cell would be configured with a measurement configuration including the aggressor UE's SRS parameters, in order to allow the interference from the aggressor UE to be measured. An example is shown in FIG. 5 where, at a particular slot, the 11^{th} OS (OFDM symbol) of gNB1 511 and gNB2 512 causes inter-cell CLI. Here, gNB1 511 has configured UE1 521, the aggressor UE, to transmit an SRS 540 and gNB2 512 has configured UE2 522, the victim UE, to measure that SRS 540. UE2 522 is provided with UE1's 521 SRS configured parameters, e.g. RS sequence used, frequency resource, frequency transmission comb structure & time resources, so that UE2 522 can measure the SRS 540. In general, a UE can be configured to monitor 32 different SRSs, at a maximum rate of 8 SRSs per slot.

For CLI-RSSI measurements, the UE measures the total received power, i.e. signal and interference, following a configured periodicity, start & end OFDM symbols of a slot, and a set of frequency Resource Blocks (RBs). Since SRS-RSRP measures a transmission by a specific UE, the network can target a specific aggressor UE to reduce its transmission power and in some cases not schedule the aggressor UE at the same time as a victim UE that reports a high SRS-RSRP measurement. In contrast, CLI-RSSI cannot be used to identify a specific aggressor UE's transmission, but CLI-RSSI does provide an overall estimate of the inter-cell CLI experienced by the victim UE.

### Remote Interference Management (RIM)

Inter-cell CLI may even occur in a network with aligned (i.e. identical) slot formats across gNBs. In particular, this may occur due to a phenomenon known as atmospheric ducting where, due to certain weather conditions, an effective waveguide may form in the atmosphere. As such, radio transmissions may be ducted (i.e. guided) from a remote aggressor gNB to a distant victim gNB potentially many kilometres away (outside the usual transmission range of the aggressor gNB). Due to propagation delay along such large distances, a DL transmission from an aggressor gNB may arrive at the victim gNB within an UL OFDM symbol or UL slot of the victim gNB, thereby causing CLI. This may be referred to as remote interference [3].

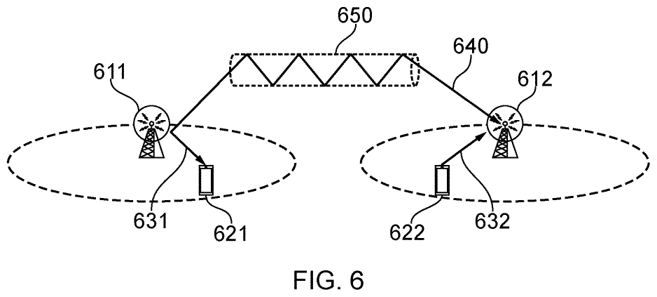

FIG. 6 shows an example of remote interference. Here gNB1 611 and gNB2 612 may be remote from one another (i.e. gNB2 612 is outside of the usual transmission range of gNB1 611). A DL transmission 631 from gNB1 611 to UE1 621 experiences atmospheric ducting and is therefore guided through an effective waveguide across a large distance to gNB 612. At gNB2 612, the DL transmission 631 from gNB1 611 interferes 640 with UL reception from UE2 622 at gNB2 612.

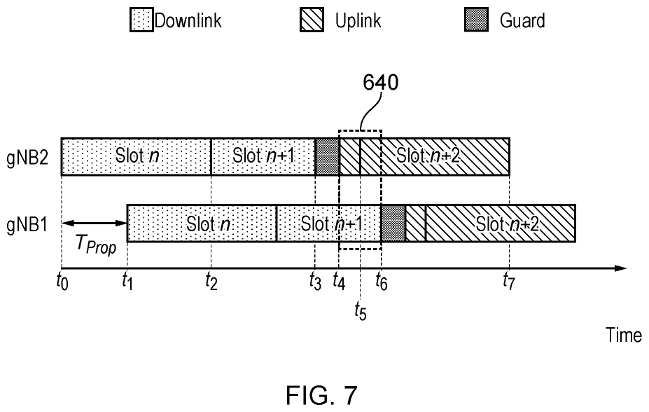

FIG. 7 illustrates remote interference in terms of the slot format and timings of gNB1 611 and gNB 612. Both gNB1 and gNB2 have the same slot format, where slot n (from time t₀ to t₂) is assigned to DL, slot n+1 (from time t₂ to t₅) is assigned to DL from time t₂ to t₃, a guard period from time t₃ to t₄ and UL from time t₄ to t₅, and slot n+2 (from time t₅ to t₇) is assigned to UL. The DL transmissions 631 from gNB1 611 arrive at gNB2 612 with propagation delay Of T_{Prop}, thereby causing the DL portion of Slot n+1 of gNB1 611 to be received until time t₆ and thus interfere 640 with the UL portion of gNB2 612 in Slot n+1 and Slot n+2, between time t₄ and t₆.

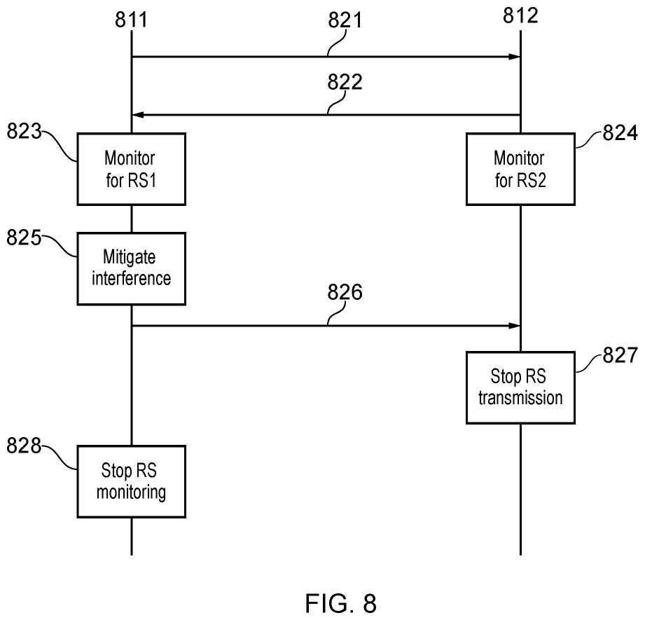

In an attempt to manage remote interference, Remote Interference Management (RIM) has been introduced. RIM introduces two Reference Signals (RS): RIM-RS1 and RIM-RS2, where RIM-RS1 is transmitted by a victim gNB and RIM-RS2 is transmitted by an aggressor gNB. The RIM process is described with reference to FIG. 8. The process is as follows:
Step 0: The victim gNB 812 experiences Remote Interference, e.g. an increase in Interference Over Thermal (IOT), as a result of transmissions 821 from the aggressor gNB 811.
Step 1: The victim gNB 812 begins transmitting RIM-RS1 822 and monitoring 824 for RIM-RS2 transmissions. The victim gNB 812 may also inform Operations, Administration and Maintenance (OAM) that it has commenced the RIM process, and the OAM would then instruct the aggressor gNB 811 to start monitoring 823 for RIM-RS1. The aggressor gNB 811 may alternatively begin monitoring 823 for RIM-RS1 822 when it also experiences remote interference.
Step 2: The aggressor gNB 811 applies remote interference mitigation schemes 825 to attempt to reduce the level of remote interference at the victim gNB 812. For example, the aggressor gNB 811 may reduce its DL transmission 821 power or may mute certain DL OFDM symbols that may cause remote interference at the victim gNB 812. The aggressor gNB 811 also begins transmitting RIM-RS2 826. The victim gNB 812 can then use RIM-RS2 826 to detect the level of remote interference from the aggressor gNB 811.
Step 3: Step 2 continues until the level of remote interference disappears or reduces to an acceptable level, at which point the victim gNB 812 will stop transmitting 827 RIM-RS1.
Step 4: When the aggressor gNB 811 is no longer able to detect RIM-RS1 822, the aggressor gNB 811 determines that the remote interference mitigation scheme 825 applied has been successful, or the atmospheric ducting has disappeared, and thus that the remote interference at the victim gNB 812 has disappeared or reduced to an acceptable level. The victim gNB 812 may also inform the OAM that the remote interference is no longer an issue and the OAM signals this information to the aggressor gNB 811 so that the aggressor gNB 811 is aware of the interference not being an issue at the victim gNB 812. The aggressor gNB 811 will then stop monitoring 828 for RIM-RS1 822 and stop transmitting RIM-RS2 826.

In this manner, remote interference at a victim gNB can be eliminated or reduced to an acceptable level. Here, RIM-RS1 can be used by the victim gNB as an indicator of whether the current mitigation steps taken by the aggressor gNB are adequate. For example, RIM-RS1 indicates whether the mitigation steps are adequate and no further action is needed, or whether the mitigation steps are not adequate and further mitigation steps are needed. Accordingly, the aggressor gNB is made aware of whether its mitigation steps can successfully reduce the remote interference. The use of RIM-RS1 as such an indicator can be enabled or disabled by the OAM.

Furthermore, the set of gNBs may be associated with a Set ID, where they are configured to use the same RIM-RS. An aggressor gNB detecting a RIM-RS can report the associated Set ID to the OAM. The OAM may then use this information to identify the set of victim gNBs affected by remote interference from this aggressor gNB.

### Intra-Cell Cross Link Interference (CLI)

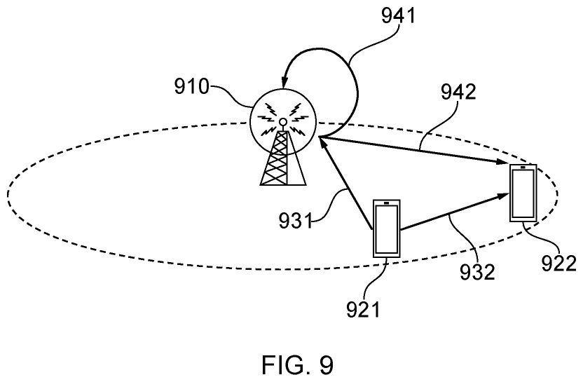

In addition to inter-cell CLI and remote interference, FD-TDD also suffers from intra-cell CLI at the gNB and at the UE. An example is shown in FIG. 9, where a gNB 910 is capable of FD-TDD and is simultaneously receiving UL transmission 931 from UE1 921 and transmitting a DL transmission 942 to UE2 922. At the gNB 910, intra-cell CLI is caused by the DL transmission 942 at the gNB's transmitter self-interfering 941 with its own receiver that is trying to decode UL signals 931. At UE2 922, intra-cell CLI 932 is caused by an aggressor UE, e.g. UE1 921, transmitting in the UL 931, whilst a victim UE, e.g. UE2 922, is receiving a DL signal 942.

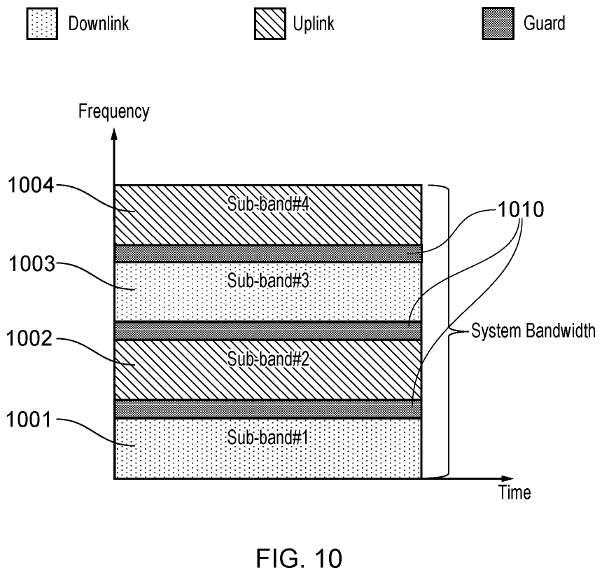

The intra-cell CLI at the gNB due to self-interference can be significant, as the DL transmission can in some cases be over 100 dB more powerful than the UL reception. Accordingly, complex RF hardware and interference cancellation are required to isolate this self-interference. In order to reduce self-interference at the gNB, one possibility is to divide the system (i.e. UE/gnB) bandwidth into non-overlapping sub-bands 1001-1004, as shown in FIG. 10, where simultaneous DL and UL transmissions occur in different sub-bands 1001-1004, i.e. in different sets of frequency Resource Blocks (RB). As will be understood by one skilled in the art, this is known as Sub-band Full Duplex (SBFD). While FIG. 10 shows the system bandwidth as being divided into four sub-bands, substantially any number of sub-bands could be used. For example, the system bandwidth may be divided into three sub-bands, which may include two downlink sub-bands 1001, 1003 and one uplink sub-band 1002, however other sub-band arrangements are envisioned.

To reduce leakage from one sub-band 1001-1004 to another, a guard sub-band 1010 may be configured between UL and DL sub-bands 1001-1004. An example is shown in FIG. 10, where a TDD system bandwidth is divided into 4 sub-bands 1001, 1002, 1003, 1004: Sub-band #1 1001, Sub-band #2 1002, Sub-band #3 1003 and Sub-band #4 1004 such that Sub-band #1 1001 and Sub-band #3 1003 are used for DL transmissions whilst Sub-band #2 1002 and Sub-band #4 1004 are used for UL transmissions. Guard sub-bands 1010 are configured between UL Sub-band #4 1004 and DL Sub-band #3 1003, between DL Sub-band #3 1003 and UL Sub-band #2 1002 and between UL Sub-band #2 1002 and DL Sub-band #1 1001. The arrangement of sub-bands 1001-1004 shown in FIG. 10 is just one possible arrangement of the sub-bands and other arrangements are possible, and guard bands may be used in substantially any sub-band arrangement.

### Inter Sub-Band Interference

Although a transmission is typically scheduled within a specific frequency channel (or sub-band), i.e. a specific set of RBs, transmission power can leak out to other channels. This occurs because channel filters are not perfect, and as such the roll-off of the filter will cause power to leak into channels adjacent to the intended specific frequency channel. While the following discussion uses the term “channel”, the term “sub-band”, such as the sub-bands shown in FIG. 10, may be used instead.

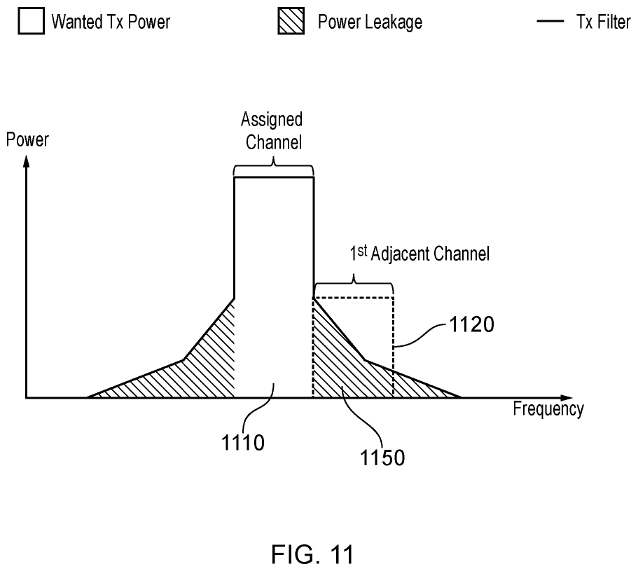

An example of transmission generating adjacent channel leakage is shown in FIG. 11. Here, the wanted transmission (Tx) power is the transmission power in the selected frequency band (i.e. the assigned channel 1110). Due to roll-off of the transmission filter and nonlinearities in components of the transmitter, some transmission power is leaked into adjacent channels (including an adjacent channel 1120), as shown in FIG. 11. The ratio of the power within the assigned frequency channel 1110 to the power in the adjacent channel 1120 is the Adjacent Channel Leakage Ratio (ACLR). The leakage power 1150 will cause interference at a receiver that is receiving the signal in the adjacent channels 1120.

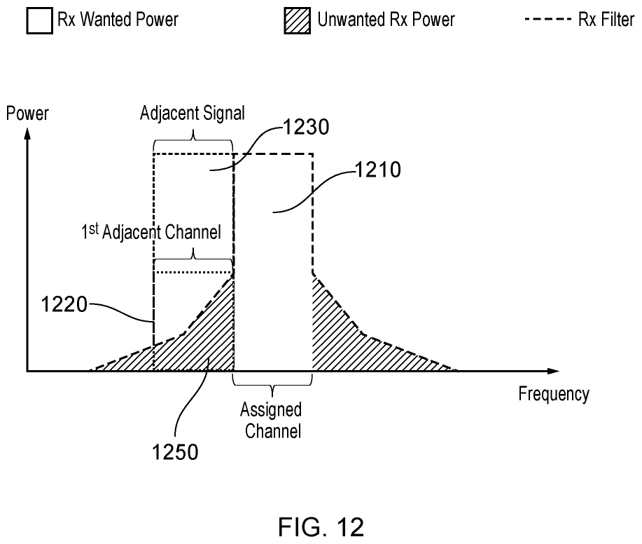

Similarly, a receiver's filter is also not perfect and will receive unwanted power from adjacent channels due to its own filter roll-off. An example of filter roll-off at a receiver is shown in FIG. 12. Here, a receiver is configured to receive transmissions in an assigned channel 1210, however the imperfect nature of the receiver filter means that some transmission power 1250 can be received in adjacent channels 1220. Therefore, if a signal 1230 is transmitted on an adjacent channel 1220, the receiver will inadvertently receive the adjacent signal 1230 in the adjacent channel 1220, to an extent. The ratio of the received power in the assigned frequency channel 1210 to the received power 1250 in the adjacent channel 1220 is the Adjacent Channel Selectivity (ACS).

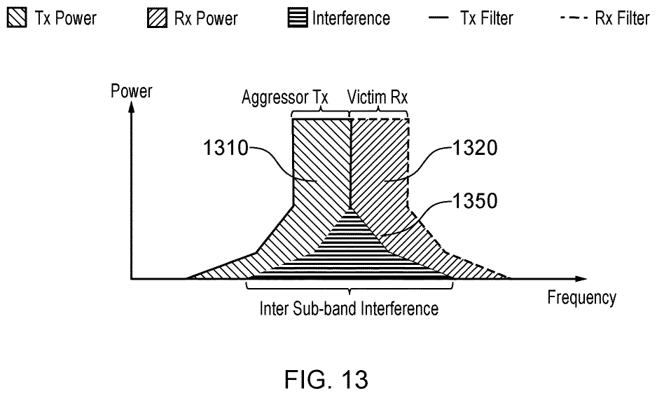

The combination of the ACL from the transmitter and the ACS of a receiver will lead to adjacent channel interference (ACI), otherwise known as inter-sub-band interference, at the receiver. An example is shown in FIG. 13, where an aggressor transmits a signal 1310 in an adjacent channel at a lower frequency than the victim's receiving 1320 channel. The interference 1350 caused by the aggressor's transmission includes the ACL of the aggressor's transmitting filter and the ACS of the victim's receiving filter. In other words, the receiver will experience interference 1350 in the ACI frequency range shown in FIG. 13.

As such, due to adjacent channel interference (ACI), cross link interference (CLI) will still occur despite the use of different sub-bands 1001-1004 for DL and UL transmissions in a FD-TDD cell. The proposed SRS-RSRP and CLI-RSSI measurements specified for inter-cell CLI assume that an aggressor and a victim transmit and receive in the same frequency channel. That is, the measurements for SRS-RSRP and CLI-RSSI at a victim UE are performed in the same frequency channel as the aggressor's frequency channel. These approaches therefore do not take into account ACI and the use of sub-bands 1001-1004 to provide information for the scheduler to mitigate against intra-cell CLI.

### Intra Sub-Band Interference

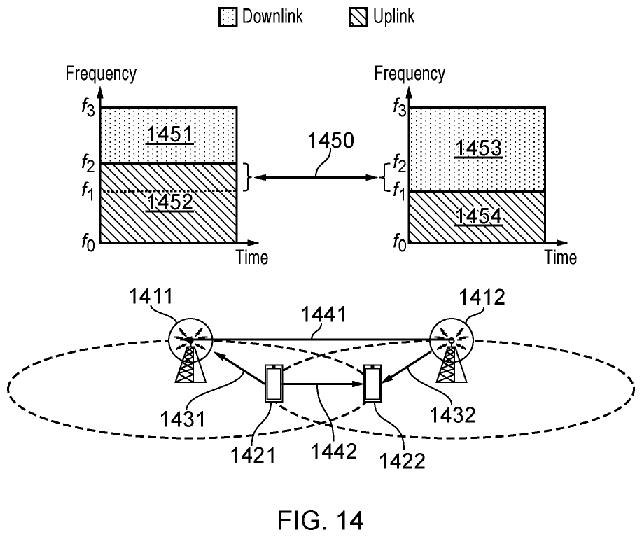

Intra sub-band interference can occur when the sub-band configurations among gNBs are not aligned in the frequency domain. Here, CLI may occur in the overlapping frequencies of inter-cell sub-bands. An example is shown in FIG. 14, where gNB1's 1411 system bandwidth is divided into UL sub-band UL-SB #1 1452 occupying f₀ to f₂ and DL sub-band DL-SB #1 1451 occupying f₂ to f₃, whilst gNB2's 1412 system bandwidth is divided into UL sub-band UL-SB #2 1454 occupying f₀ to f₁ and DL sub-band DL-SB #2 1453 occupying f₁ to f₃. The non-aligned sub-band configurations 1450 cause UL-SB #1 1452 to overlap with DL-SB #2 1453, thereby causing intra sub-band CLI within the overlapping frequencies f₁ to f₂. In this example, intra sub-band CLI 1441 occurs at gNB1 1411 due to gNB2's 1412 DL transmission 1432 within f₁ to f₂ in DL-SB #2 1453 interfering with gNB1's 1411 UL reception 1431 from UE1 1421 within f₁ to f₂ in UL-SB #1 1452. In addition, intra sub-band CLI 1442 occurs at UE2 1422 due to UE1's 1421 UL transmission 1431 within f₁ to f₂ in UL-SB #1 1452 interfering with UE2's 1422 DL reception 1432 within f₁ to f₂ in DL-SB #2 1453.

As explained above, inter cell CLI and intra sub-band CLI can be caused by misalignment of slot format and sub-band configurations among gNBs in a wireless communications network. Although aligning the slot format and sub-band configurations among gNBs may reduce CLI, it would also reduce the flexibility and dynamism for each gNB to independently manage its resources to adapt to traffic. In other words, statically aligning these configurations would defeat the purpose of Duplex Evolution.

If the flexibility and dynamism for each gNB to configure its slot format and sub-band are maintained, then one way to manage the CLI is to control the transmission power of the gNBs and the UEs. Legacy power control is typically performed within a cell, i.e. on a per gNB, basis, rather than across cells or gNBs.

In order to manage power control among gNBs to reduce inter-cell CLI, coordination among gNBs has been proposed. For example, it has been proposed [4] that a victim gNB should provide feedback to an aggressor gNB via an Xn interface that it is experiencing high CLI. In response, the aggressor gNB can reduce its DL transmission power which reduces CLI and improves overall system capacity. The feedback may be in the form of a RIM-RS as explained previously. For example, the RIM-RS from the victim gNB can indicate whether or not “enough mitigation” is being used by the aggressor gNB. However, the Xn interface operates at a higher layer with latencies at multiples of 20 ms therefore slow to respond to dynamic changes in CLI. Therefore, to reduce latency for signalling the feedback between gNBs, Over The Air (OTA) backhaul signalling for gNB-gNB coordination to manage CLI has been proposed for faster signalling among gNBs [5].

However, the currently proposed methods of reducing CLI by gNB coordination suffer from several drawbacks. For example, current methods assume that there is only one aggressor gNB and one victim gNB. In such schemes the victim gNB assumes that the aggressor gNB will perform the mitigation such as by reducing its transmission power or by muting one or more OFDM symbols. However, unlike the case in RIM-RS and dynamic/flexible TDD where the entire OFDM symbol is either UL or DL, in SBFD, two or more gNBs can be both aggressors and victims.

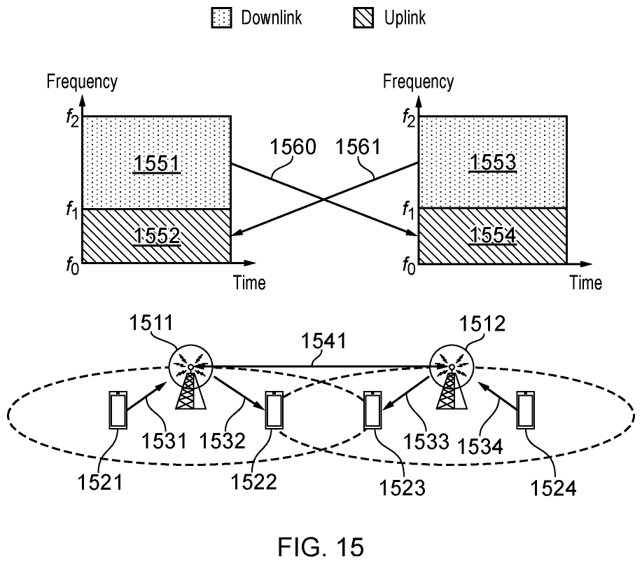

An example two gNBs acting as both an aggressors and victims is shown in FIG. 15. As shown in FIG. 15, gNB1 1511 and gNB2 1512 have the same sub-band format. In particular, the system bandwidth f₀ to f₂ for gNB1 1511 is divided into UL sub-band #1 1552 occupying frequencies f₀ to f₁ and a DL sub-band #1 1551 occupying frequencies f₁ to f₂. Similarly, the system bandwidth f₀ to f₂ for gNB2 1512 is divided into a UL sub-band #2 1554 occupying frequencies f₀ to f₁ and a DL sub-band #2 1553 occupying frequencies f₁ to f₂. As shown in FIG. 15, gNB1 1511 simultaneously receives UL 1531 from UE1 1521 in UL sub-band #1 1552 and transmits DL 1532 to UE2 1522 using DL sub-band #1 1551. During the same time period, gNB2 1512 receives UL 1534 from UE4 1524 in UL sub-band #2 1554 and transmits DL 1533 to UE3 1523 using DL sub-band #2 1553. The DL transmission 1532 from gNB1 1511 causes inter sub-band interference 1560 to the UL reception 1534 of gNB2 1512 and at the same time the DL transmission 1533 from gNB2 1512 causes inter sub-band interference 1561 to the UL reception 1531 of gNB1 1511. Therefore, both gNB1 1511 and gNB2 1512 are victims and aggressors of inter-cell CLI 1541 at the same time.

If currently proposed methods of CLI coordination among gNBs are applied to the gNBs shown in FIG. 15, then, since both gNBs experience interference, both gNBs may unnecessarily perform CLI mitigation. This may mean that, if an important transmission (e.g. URLLC transmission) interferes with a less important transmission (e. g an eMBB transmission), the important transmission may be unnecessarily delayed or have its transmission power reduced to reduce interference.

Therefore, there is a need for improved methods, infrastructure equipment communications devices, and systems for controlling CLI in a wireless communications network.

In view of the above, there is provided a method of controlling cross-link interference, CLI, by infrastructure equipment of a wireless communications network. The method comprises detecting a CLI priority indicator from other infrastructure equipment of the wireless communications network. The CLI priority indicator comprises an indication of a CLI priority level of the other infrastructure equipment. The method comprises determining that a wireless transmission is to be communicated between the infrastructure equipment and a communications device in a coverage area provided by the infrastructure equipment. The method comprises determining, based on a comparison of a CLI priority level of the infrastructure equipment and the CLI priority level of the other infrastructure equipment indicated by the CLI priority indicator, an extent to which one or more transmission parameters of the wireless transmission should be modified to reduce interference caused by the wireless transmission at the other infrastructure equipment. The method comprises modifying the one or more transmission parameters of the wireless transmission in accordance with the determined extent of modification.

For ease of explanation, the infrastructure equipment will be referred to herein as the “gNB” and the other infrastructure equipment will be referred to herein as the “other gNB”. However, it will be appreciated that other network infrastructure equipment could be used such as eNBs, DUs, CUs etc. Similarly, the communications device will be referred to as a “UE” and another communications device will be referred to as “another UE”.

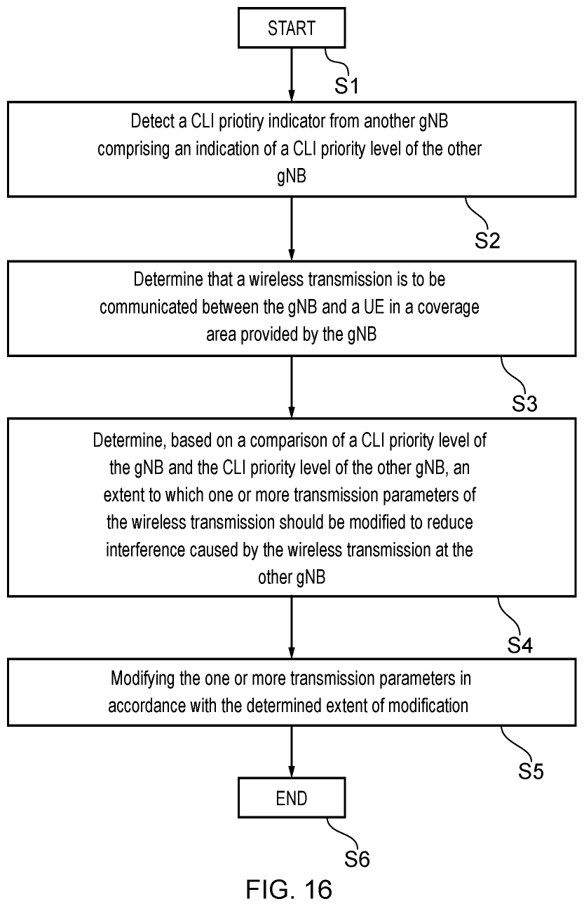

An example of a method for controlling CLI by infrastructure equipment of a wireless communications network will now be described with reference to FIG. 16. The infrastructure equipment comprises a transmitter configured to transmit signals, a receiver configured to receive signals, and a controller configured to control the transmitter and the receiver to perform the steps of FIG. 16.

The method starts at step S1.

In step S2, a gNB of a wireless communications network detects a CLI priority indicator from another gNB. The CLI priority indicator comprises an indication of a CLI priority level of the other gNB.

The CLI priority level may be a physical layer priority level or a logical channel priority level, for example. For example, the CLI priority level may be one of the two physical layer priority levels that are currently used for handling intra-UE collisions of PUSCH/PUCCH. In another example, the CLI priority level may be one of the 16 logical channel priority levels that are currently used in the MAC layer for handling PDUs. In general, a CLI priority level is one of a set of two or more possible CLI priority levels.

In some embodiments, the detection of the CLI priority indicator by the gNB comprises receiving the CLI priority indicator from the other gNB. The CLI priority indicator may be received Over The Air (OTA) such as via a Uu interface. Alternatively, the CLI priority indicator may be received via a backhaul interface (such as an Xn interface) between the gNBs. It is preferable to receive the CLI priority indicator via an OTA transmission because of reduced latency. An example of an OTA transmission using a physical channel is explained in more detail below. In some embodiments, the gNB may store the CLI priority indicator from the other gNB. For example, the gNB may receive the CLI priority indicator from the other gNB and store the CLI priority indicator in a memory of the gNB. In another example, the memory of the gNB may be pre-configured with the CLI priority indicator from the other gNB already stored in the memory. In embodiments where the gNB stores the CLI priority indicator from the other gNB, the detection of the CLI priority indicator from the other gNB may comprise detecting the CLI priority indicator from the other gNB from a memory of the gNB.

The CLI priority indicator may indicate time resources to which the indicated CLI priority level of the other gNB applies. In some embodiments, the CLI priority indicator indicates both the time and the frequency resources to which the indicated CLI priority level of the other gNB applies. For example, the CLI priority indicator may indicate that the indicated CLI priority level of the other gNB applies for one or more slots, sub-slots or OFDM symbols. In some embodiments, the CLI priority indicator may indicate that the indicated CLI priority level of the other gNB applies for one or more frequency Resource Blocks, RB, one or more sets of frequency RBs or one or more sub-bands to which the CLI priority level of the other gNB applies.

The CLI priority indicator may include a priority time period (T_{priority}). T_{priority} can indicate a slot, sub-slot or OFDM symbol to which the indicated CLI priority level of the other gNB applies. In particular, T_{priority} indicates the slot, sub-slot or OFDM symbol to which the CLI priority level of the other gNB applies as a number of slots, sub-slots or OFDM symbols after the slot, sub-slot or OFDM symbol in which the CLI priority indicator is received. For example, if T_{priority}=5 slots, then the gNB determines that the indicated CLI priority level of the other gNB applies to the slot which is 5 slots from the slot in which the CLI priority indicator was transmitted.

In some embodiments, the indicated time and frequency resources include time and frequency resources in which another wireless transmission to be communicated between the other gNB and another UE in a coverage area provided by the other gNB. For example, the other gNB may be receiving a high priority URLLC uplink transmission and indicates a high CLI priority level of the other gNB for the duration of the URLLC uplink transmission. Alternatively, the other gNB may be receiving a low priority eMBB uplink transmission and indicates a low CLI priority level of the other gNB for the duration of the eMBB uplink transmission.

In some embodiments, the CLI priority indicator does not indicate the time resources to which the CLI priority level of the other gNB applies. For example, the CLI priority indicator may indicate the CLI priority level of the other gNB, but not when it is to be applied. In embodiments where the time resources are not indicated by the CLI priority indicator, the CLI priority indicator may still indicate the frequency resources to which the CLI priority level of the gNB applies. For example, the CLI priority indicator may indicate one or more sub-bands to which the CLI priority level of the other gNB applies. In embodiments where the time resources are not indicated by the CLI priority indicator, the value of when the CLI priority level of the other gNB applies may be configured by the network and signalled to the gNBs in the network or fixed in the specifications. For example, the value of Tpriority can be configured by the network and signalled to the gNBs in the network or it can be fixed in the specifications.

In some embodiments, the CLI priority indicator indicates that the CLI priority level of the other gNB applies until further notice. In some embodiments, the gNB may receive a signal from the other gNB indicating that the indicated CLI priority level of the other gNB no longer applies. In some embodiments, the gNB may receive an updated CLI priority indicator from the other gNB to update the previously indicated CLI priority level of the other gNB. In other words, the indicated CLI priority level of the other gNB is valid until the other gNB indicates another CLI priority level to overwrite the previous one. For example, the other gNB may indicate a high CLI priority level and the gNB determines that the high CLI priority level of the other gNB applies for every subsequent slot until the gNB receives an updated CLI priority indicator to overwrite the indicated CLI priority level.

In some embodiments, as explained in more detail below, the CLI indicator comprises one or more reference signals (referred to hereafter as “Priority-RS”), and the gNB determines the CLI priority level of the other gNB based on the Priority-RS.

In step S3, the gNB determines that a wireless transmission is to be communicated between the gNB and a UE in a coverage area provided by the gNB.

If the detected CLI priority indicator indicates time resources to which the CLI priority level of the other gNB applies, the gNB may determine that the wireless transmission overlaps with the indicated time resources. If the detected CLI priority indicator indicates time and frequency resources to which the CLI priority level of the other gNB applies, the gNB may determine that the wireless transmission overlaps with the indicated time and frequency resources. For example, the gNB may determine that the wireless transmission overlaps with one or more sub-slots, slots or OFDM symbols indicated by the detected CLI priority indicator.

In step S4, the gNB determines, based on a comparison of a CLI priority level of the gNB and the CLI priority level of the other gNB indicated by the CLI priority indicator, an extent to which one or more transmission parameters of the wireless transmission should be modified to reduce interference caused by the wireless transmission at the other gNB.

The interference caused by the wireless transmission at the other gNB may be interference to another wireless transmission to be communicated between the other gNB and another UE in a coverage area provided by the other gNB. For example, the wireless transmission may overlap in time with the other wireless transmission to be communicated between the other gNB and the other UE in the coverage area provided by the other gNB.

The wireless transmission and other wireless transmission may also overlap in frequency. However, as explained previously, inter-sub band CLI means that transmissions can interfere even if they do not overlap in frequency because of transmission/reception power leakage.

The wireless transmission and the other wireless transmission may be uplink or downlink transmissions. For example, the wireless transmission may be a downlink transmission and the other wireless transmission may be an uplink transmission.

The one or more transmission parameters of the wireless transmission may comprise a transmission power of the wireless transmission, a start time of the wireless transmission a frequency of the wireless transmission, and a modulation and coding scheme (MCS) to be used for the wireless transmission, for example.

In one example, the gNB determines that the CLI priority level of the other gNB is higher than the CLI priority level of the gNB, and therefore reduces transmission power of the wireless transmission. For example if the wireless transmission is a downlink transmission, then reducing the transmission power of the downlink transmission reduces interference caused by the downlink transmission at the other gNB.

In another example, the gNB determines that the CLI priority level of the other gNB is higher than the CLI priority level of the gNB, and therefore delays the start time of the wireless transmission to reduce overlap, or completely remove overlap, in time between the wireless transmission and the indicated time resources to which the CLI priority level of the other gNB applies. For example if CLI priority indicator indicates that the CLI priority level of the other gNB applies to a time period, and the gNB determines that the wireless transmission overlaps in time with the indicated time period, then the gNB may delay the start time of the wireless transmission until after the indicated time period or at least to reduce overlap between the wireless transmission and the indicated time period.

In another example, the gNB determines that the CLI priority level of the other gNB is higher than the CLI priority level for the gNB, the CLI priority indicates time and frequency resources to which the CLI priority level of the other gNB applies, and the gNB determines that the wireless transmission overlaps in time and frequency with the indicated time and frequency resources. The gNB may determine to reduce a transmission power of the wireless transmission for the entire wireless transmission or at least the duration of the wireless transmission which overlaps with the indicated time resources. The gNB may determine to delay a start time of the wireless transmission to completely remove overlap or at least reduce overlap with the indicated time resources.

Examples given above describe that the wireless transmission has its transmission power reduced, or start time delayed, if the CLI priority level of the other gNB is higher than the CLI priority level of the gNB. In other examples the transmission power may be reduced or the start time may be delayed even if the CLI priority level of the gNB is higher than the CLI priority level of the other gNB. For example, the gNB may reduce the transmission power or delay the start time to a lesser extent if the CLI priority level of the gNB is higher than the CLI priority level of the other gNB as compared with when the CLI priority level of the other gNB is higher than the CLI priority level of the gNB.

In some embodiments, the gNB determines a difference between the CLI priority levels and determines the extent of modification based on the difference. For example, if the CLI priority level of the other gNB is very high, then the gNB may reduce the transmission power of a downlink transmission to a very low level. In some cases, the gNB may refrain from transmitting the downlink transmission (that is, the transmission power is reduced to zero).

In some embodiments, the gNB may transmit a CLI priority indicator to the other gNB indicating a CLI priority level of the gNB. Therefore, the gNB and the other gNB can be made aware of each other's CLI priority level. In some embodiments, the gNB and the other gNB may determine their respective CLI priority levels based on a priority of the wireless transmission and the other wireless transmission respectively. For example, URLLC transmissions may have a higher CLI priority level than eMBB transmissions.

In some embodiments, the gNB and the other gNB may determine their respective CLI priority levels based on their respective gNB-type. For example, a gNB operating in a factory compound may have a higher CLI priority than a gNB primarily used for web browsing.

In step S5, the gNB modifies the one or more transmission parameters of the wireless transmission in accordance with the determined extent of modification.

The extent of modification of the one or more transmission parameters may refer by an amount by which to reduce a transmission power, and/or an amount by which to delay a start time of the wireless transmission, and/or an amount by which to change a transmission frequency of the wireless transmission, for example. The modification of the transmission parameters of the wireless transmission to reduce interference caused by the wireless transmission at the other infrastructure equipment may be referred to as “CLI mitigation”.

In some cases, the determined extent of modification may be no modification (for example in cases where the CLI priority level of the gNB is higher than the CLI priority level of the other gNB). When the determined extent of modification is no modification, the one or more transmission parameters of the wireless transmission remain unchanged.

The method ends in step S6. As will be appreciated by one skilled in the art, the steps shown in FIG. 16 can be performed in any logical order (for example, step 3 may be performed before step 2 and vice versa). Following the method shown in FIG. 16, the wireless transmission is communicated according to the modified one or more transmission parameters. For example, the wireless communication may be a downlink transmission which is transmitted to the communications device according to the one or more modified transmission parameters or an uplink transmission which is received from the communications device according to the one or more modified transmission parameters. Furthermore, the gNB may transmit an indication of its CLI priority level to the other gNB and the other gNB can perform the process of FIG. 16 to determine what, if any, CLI mitigation it should perform. The gNB and the other gNB may be configured to operate according to SBFD and, in some embodiments, may have the same slot format.

The method described with respect to FIG. 16 takes into account the relative importance of interfering transmissions when performing CLI mitigation. Since the decision of how much CLI mitigation to perform is based on a comparison of CLI priority indicators, then the requirements of two gNBs can be taken into account, such as for example whether one of the gNBs has higher priority transmissions than the other gNB. Therefore, situations in which both gNBs unnecessarily perform CLI mitigation can be avoided (such as, for example, when both gNBs are victims and aggressors), or CLI mitigation can be performed to a lesser extent on the more important transmission than the less important transmission. In other words, the CLI priority indicator provides the gNB with information to decide to what extent to use CLI mitigation such as refraining from downlink transmission, uplink reception or reduction in downlink transmission power or any other CLI mitigation method which would impact the performance of UEs in the coverage areas provided by the gNBs. Furthermore, since the decision to perform CLI mitigation does not rely on detecting interference, the one or more transmission parameters can be modified in advance of transmitting the wireless transmission. This means less interference and therefore improved communications efficiency.

An example of how the above method can be implemented to improve communications efficiency when both the gNB and the other gNB are acting as victims and aggressors will now be described. Referring back to FIG. 15, assume that gNB1 1511 is an example of “the gNB” described in FIG. 16, and that gNB2 1512 is an example of “the other gNB” described with reference to FIG. 16. Furthermore, assume that downlink transmission 1532 to UE2 1522 is an example of the “wireless transmission to be communicated between the gNB and a UE in a coverage area provided by the gNB”, and that uplink transmission 1534 received from UE4 1524 is an example of the “other wireless transmission to be communicated between the other gNB and another UE in a coverage area provided by the other gNB”. As shown in FIG. 15, the downlink transmission 1532 and the uplink transmission 1534 overlap in time and may therefore interfere with each other. It is not necessary that the downlink transmission 1532 and the uplink transmission 1534 overlap in frequency for interference to be caused due to transmission/reception power leakage as explained previously. gNB2 1512 may transmit a CLI priority indicator to the gNB1 1511 comprising an indication of a CLI priority level of gNB2 1512 (the CLI priority indicator may be transmitted in advance of the downlink transmission 1532 and the uplink transmission 1534). For example, the CLI priority indicator may indicate that gNB1512 has a high CLI priority level until further notice or that gNB2 1512 has a high CLI priority level for one or more indicated slots, sub-slots or OFDM symbols. The uplink transmission 1534 may be located in the indicated slots, sub-slots or OFDM symbols. gNB1 1511 then determines, based on a comparison of a CLI priority level of gNB1 1511 and the CLI priority level of gNB2 1512 indicated by the CLI priority indicator, an extent to which one or more transmission parameters of the downlink transmission 1532 should be modified to reduce interference caused by the downlink transmission 1532 at gNB2 1512 (for example, the interference caused to the uplink transmission 1534 by the downlink transmission 1532). For example, gNB1 1511 may determine that it has a lower CLI priority level than the CLI priority level of gNB2 1512. Therefore gNB1 1511 may reduce the transmission power of the downlink transmission 1532, or delay the downlink transmission 1532 so as to reduce interference with the uplink transmission 1534. In some cases, gNB1 1511 may determine a difference between its CLI priority level and the CLI priority level of gNB2 1512 and reduce the transmission power of the downlink transmission 1532, or delay the downlink transmission 1532, to a greater extent based on the difference. As will be appreciated, this mechanism allows for interference to the uplink transmission 1534 at gNB2 1512 caused by the downlink transmission 1532 to be reduced or removed. gNB1 1511 may transmit a CLI priority indicator comprising an indication of its CLI priority level to gNB2 1512. gNB2 1512 may determine, based on a comparison of its CLI priority level and the CLI priority level of gNB1 1511, an extent to which one or more transmission parameters of the downlink transmission 1533 to be transmitted to UE3 1523 are to be modified to reduce interference caused by the downlink transmission 1533 at gNB 1511(for example, the interference caused by the downlink transmission 1533 to the uplink transmission 1531 to be received at gNB1 1511 from UE1 1521). For example, gNB2 1512 may determine that it has a higher CLI priority level than gNB1 1511. Therefore, gNB2 1512 may transmit the downlink transmission 1533 with no modification (i.e. the extent to which the transmission parameters are to be modified is determined to be zero), or gNB 1512 may perform more CLI mitigation on the downlink transmission 1533 than gNB1 1511 performs on its downlink transmission 1532. For example, gNB1 1511 may reduce the transmission power of the downlink transmission 1532 to UE2 522 to a greater extent than gNB2 1512 reduces the transmission power of the downlink transmission 1533 to UE3 1523.

As explained previously, according to currently proposed methods, gNB1 1511 would perform CLI mitigation on downlink transmission 1532 based on interference feedback received from gNB2 1512 while gNB2 1512 would perform CLI mitigation on downlink transmission 1533 based on interference feedback received from gNB1 1511. The method described above allows the importance of transmissions to be taken into account when performing CLI mitigation such that more important transmissions can be modified to a lesser extent than less important transmissions. Currently proposed methods are blind to the importance of the transmissions which can result in important transmissions having to be retransmitted or delayed because an unnecessarily large amount of CLI mitigation was applied.

### Priority-RS

As mentioned above, the CLI priority indicator may comprise one or more reference signals which will be collectively referred to as “Priority-RS”.

In some embodiments, the gNB determines the CLI priority level of the other gNB based on a sequence of the Priority-RS. For example, 16 different sequences can be used to indicate 16 different CLI priority levels.

In some embodiments, the gNB may determine the CLI priority level of the other gNB based on a cyclic shift of a base sequence of the Priority-RS. For example, 16 different cyclic shifts can be used to indicate 16 different CLI priority levels.

In some embodiments, the location in frequency and/or time of the Priority-RS indicates the CLI priority level of the other gNB. For example, for case where 2 CLI priority levels are used, Priority-RS in the 1^{st} OFDM symbol of a slot of a downlink sub-band indicates a high CLI priority level and a Priority-RS in the 2^{nd} OFDM symbol of the slot indicates a low CLI priority level.

In some embodiments, the sequence of the Priority-RS indicates the Cell ID or Cell ID Group of the gNB.

In some embodiments, the location in frequency and/or time of the Priority-RS indicates the Cell ID or Cell ID Group of the gNB.

In some embodiments, the gNB will only take into account the CLI priority level of the other gNB if the received Priority-RS is above a power threshold T_{Pwr}. In other words, the gNB ignores the CLI priority level of the other gNB if a detected power of the Priority-RS is below T_{Pwr}. This recognizes that if the gNB detects a Priority-RS at a low power level from the other gNB, then it is likely that the CLI caused by the gNB to the other gNB is also likely to be low and therefore there is no need for the gNB to apply any further CLI mitigation for the other gNB. In some cases, the other gNB may determine not to transmit any Priority-RS if it decides that it has no wireless transmissions to be communicated, or if the wireless transmissions have a very low CLI priority level. Therefore, the gNB would not detect any Priority-RS and would not apply any CLI mitigation.

In some embodiments, a CLI priority level can be indicated by not transmitting any Priority-RS. For example, if there are 3 CLI priority levels, then the lowest priority is not transmitting any Priority-RS, the medium priority is to transmit the Priority-RS with cyclic shift 1 and highest priority is to transmit the Priority-RS with cyclic shift 2.

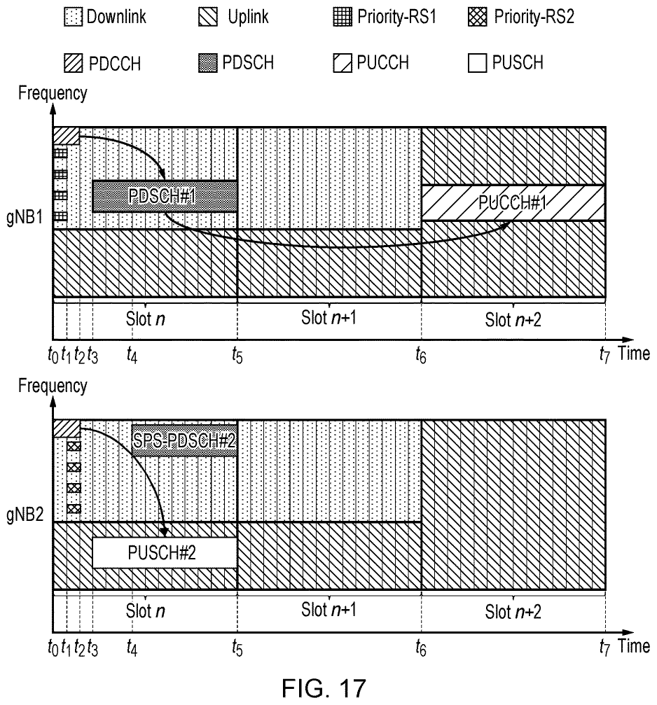

An example in which a Priority-RS is used to indicate a CLI priority level of two gNBs operating according to SBFD is shown in FIG. 17. In Slot n, gNB1 schedules PDSCH #1 to start at time t₃ to t₅ and schedules the associated PUCCH for carrying HARQ-ACK in Slot n+2. In the same Slot n, gNB2 schedules PUSCH #2 to start at time t₃ to t₅, and schedules an SPS-PDSCH #2 at time t₄ to t₅. In Slot n, gNB1's PDSCH #1 transmission would cause inter sub-band interference to gNB2's PUSCH #2 reception but gNB2's SPS-PDSCH #2 does not cause any CLI to gNB1 since gNB1 is not receiving any uplink transmission. In accordance with example embodiments, gNB1 transmits Priority-RS1 on the downlink between t₀ to t₁ (before PDSCH #1 transmission) to indicate to gNB2 that gNB1 has a low CLI priority level. For example, gNB2 may detect Priority-RS1 and determine that gNB1 has a low CLI level priority. Similarly, gNB2 transmits Priority RS-2 on the downlink between t₁ to t₂ (before SPS-PDSCH #2 and PUSCH #2 transmission) to indicate to gNB1 that gNB2 has a high CLI priority level. Priority RS1 and Priority RS2 may indicate their respective CLI priority levels by, for example, using different cyclic-shifts and/or different base sequences for the Cell ID.

Since gNB2's Priority-RS2 indicates a higher CLI priority level than gNB1's priority level, gNB1 executes CLI mitigation on PDSCH #1. For example, gNB1 may reduce the transmission power of PDSCH #1 to reduce inter sub-band interference to gNB2. At gNB2's side, it detects that gNB1 has a lower CLI priority level and so it transmits SPS-PDSCH #2 without any CLI mitigation.

It will be appreciated by one skilled in the art that applying a conventional CLI mitigation method such as RIM-RS to the scenario shown in FIG. 17 may result in gNB2 unnecessarily reducing the transmission power for SPS-PDSCH #2 because gNB2 would not know that gNB1 has no uplink transmission. For example, in a RIM-RS method, gNB1 may detect interference caused by gNB2's SPS-PDSCH #2 transmission and, in response send RIM-RS to gNB2. gNB1 may then decide that it is a victim. gNB2 detecting gNB1's RIM-RS will then apply mitigation CLI on the on the SPS-PDSCH #2 transmission. This would impact gNB2's reception performance without solving any CLI at gNB1 since gNB1 isn't even receiving any uplink transmission.

The example described with reference to FIG. 17 shows that gNB1 can use the Priority-RS to indicate the absence of uplink reception by indicating the lowest priority level so that other gNBs does not need to perform any CLI mitigation.

CLI Priority Indicator in Physical Channel

In some embodiments, the CLI priority indicator is transmitted OTA in a physical channel. The physical channel may be a new physical channel adapted for transmitting the CLI priority indicator. Alternatively, the physical channel may be an existing physical channel such as PDCCH, PDSCH, PUCCH or PUSCH.

In some embodiments, the CLI priority indicator is transmitted OTA in PDCCH. The PDCCH configurations, such as its search space, aggregation level, RNTI, etc, are known to the gNB receiving the CLI priority indicator. The gNB receiving the CLI priority indicator can blind decode for the PDCCH in the search space.

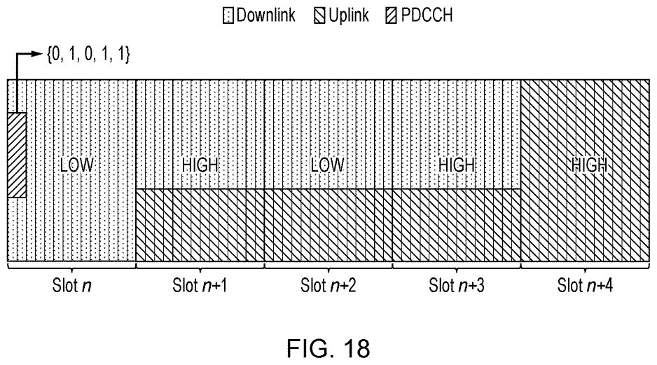

An example in which a CLI priority indicator is transmitted in a physical channel is shown in FIG. 18. In particular, FIG. 18 shows a bitmap of a CLI priority indicator using PDCCH. The PDCCH shown in FIG. 18 carries a CLI priority indicator which indicates a plurality of CLI levels. In particular, a bitmap of 5 bits is used to indicate two CLI priority levels (“1”=High, “0”=Low) for 5 consecutive slots. In Slot n, the PDCCH carrying the indicator is transmitted with a bitmap {0, 1, 0, 1, 1} indicating that Slot n, n+1, n+2, n+3 & n+4 have priorities Low, High, Low, High & High respectively. Therefore, if the gNB receiving the PDCCH determines that it has a downlink transmission to transmit to a UE in slot n, then the gNB may apply a low level of CLI mitigation to the downlink transmission (e.g. reducing the transmission power of the downlink transmission only by a small amount or not at all). By contrast if the gNB determines that it has a downlink transmission to transmit to a UE in slot n+1, then it may apply a high level of CLI mitigation to the downlink transmission (e.g. reducing the transmission power of the downlink transmission by a large amount or completely refraining from transmitting the downlink transmission).

In accordance with example embodiments, there is provided a method of controlling cross-link interference, CLI, by a communications device in a coverage area provided by infrastructure equipment of a wireless communications network. The method comprises determining that a wireless transmission is to be communicated between the communications device and the infrastructure equipment. The wireless transmission may be an uplink transmission to be transmitted by the communications device to the infrastructure equipment or the wireless transmission may be a downlink transmission to be received by the communications device from the infrastructure equipment. The method comprises receiving, from the infrastructure equipment, an indication of an extent to which one or more transmission parameters of the wireless transmission are to be modified by the infrastructure equipment to reduce interference caused by the wireless transmission at other infrastructure equipment of the wireless communications network. The extent to which the one or more transmission parameters are to be modified by the infrastructure equipment are determined by the infrastructure equipment based on a comparison of a CLI priority level of the infrastructure equipment and a CLI priority level of the other infrastructure equipment. The one or more transmission parameters may include a transmission power of the wireless transmission, a start time of the wireless transmission, a frequency of the wireless transmission or a modulation and coding scheme (MCS) to be used for the wireless transmission, for example. The method comprises communicating the wireless transmission with the infrastructure equipment in accordance with the modified one or more transmission parameters.

The following numbered paragraphs provide further example aspects and features of the present technique:

Paragraph 1. A method of controlling cross-link interference, CLI, by infrastructure equipment of a wireless communications network, the method comprising
detecting a CLI priority indicator from other infrastructure equipment of the wireless communications network, the CLI priority indicator comprising an indication of a CLI priority level of the other infrastructure equipment,
determining that a wireless transmission is to be communicated between the infrastructure equipment and a communications device in a coverage area provided by the infrastructure equipment,
determining, based on a comparison of a CLI priority level of the infrastructure equipment and the CLI priority level of the other infrastructure equipment indicated by the CLI priority indicator, an extent to which one or more transmission parameters of the wireless transmission should be modified to reduce interference caused by the wireless transmission at the other infrastructure equipment, and
modifying the one or more transmission parameters of the wireless transmission in accordance with the determined extent of modification.

Paragraph 2. A method according to paragraph 1, wherein the determining the extent to which the one or more transmission parameters of the wireless transmission should be modified to reduce interference caused by the wireless transmission at the other infrastructure equipment comprises
determining, based on the comparison of the CLI priority level of the infrastructure equipment and the CLI priority level of the other infrastructure equipment, a difference between the CLI priority level of the infrastructure equipment and the CLI priority level of the other infrastructure equipment, and
determining the extent to which the one or more transmission parameters of the wireless transmission should be modified to reduce interference caused by the wireless transmission at the other infrastructure equipment based on the determined difference, wherein
the greater the determined difference between the CLI priority level of the infrastructure equipment and the CLI priority level of the other infrastructure equipment, the greater the determined extent of modification of the one or more transmission parameters.

Paragraph 3. A method according to paragraph 1 or paragraph 2, wherein the determining the extent to which the one or more transmission parameters of the wireless transmission should be modified to reduce interference caused by the wireless transmission at the other infrastructure equipment comprises
determining an extent to which a transmission power of the wireless transmission should be reduced.

Paragraph 4. A method according to any of paragraphs 1 to 3, wherein the CLI priority indicator comprises
an indication of time resources to which the CLI priority level of the other infrastructure equipment applies.

Paragraph 5. A method according to paragraph 4, wherein the indication of the time resources is an indication of a pre-defined time period.

Paragraph 6. A method according to paragraph 4 or paragraph 5, wherein the indicated time resources include time resources in which another wireless transmission is to be communicated between the other infrastructure equipment and another communications device in a coverage area provided by the other infrastructure equipment.

Paragraph 7. A method according to any of paragraphs 4 to 6, wherein the determining that the wireless transmission is to be communicated between the infrastructure equipment and the communications device in the coverage area provided by the infrastructure equipment comprises
determining that the wireless transmission overlaps with the indicated time resources.

Paragraph 8. A method according to paragraph 7, wherein the determining the extent to which the one or more transmission parameters of the wireless transmission should be modified to reduce interference caused by the wireless transmission at the other infrastructure equipment comprises
determining an extent to which a start time of the wireless transmission should be delayed to reduce the overlap with the indicated time resources.

Paragraph 9. A method according to paragraph 7 or paragraph 8, wherein the determining the extent to which the one or more transmission parameters of the wireless transmission should be modified to reduce interference caused by the wireless transmission at the other infrastructure equipment comprises
determining an extent to which a transmission power of the wireless transmission should be reduced for at least the duration of the overlap with the indicated time resources.

Paragraph 10. A method according to any of paragraphs 4 to 9, wherein the CLI priority indicator comprises
an indication of frequency resources to which the CLI priority level of the other infrastructure equipment applies.

Paragraph 11. A method according to paragraph 10, wherein the indication of the time resources and the frequency resources comprises
an indication of one or more slots or sub-slots to which the CLI priority level of the other infrastructure equipment applies.

Paragraph 12. A method according to paragraph 11, wherein the indication of the one or more slots or sub-slots comprises
an indication of one or more OFDM symbols in the one or more slots or sub-slots to which the CLI priority level of the other infrastructure equipment applies.

Paragraph 13. A method according to paragraph 10, wherein the indication of the time resources and the frequency resources comprises
an indication of one or more frequency Resource Blocks, RB, one or more sets of frequency RBs or one or more sub-bands to which the CLI priority level of the other infrastructure equipment applies.

Paragraph 14. A method according to any of paragraphs 10 to 13, wherein the indication of the time and frequency resources comprises
uplink resources for the infrastructure equipment which overlap in time and frequency with downlink resources for the other infrastructure equipment, or
downlink resources for the infrastructure equipment which overlap in time and frequency with uplink resources for the other infrastructure equipment.

Paragraph 15. A method according to any of paragraphs 10 to 14, wherein the indicated time and frequency resources include time resources and frequency resources in which another wireless transmission is to be communicated between the other infrastructure equipment and another communications device in a coverage area provided by the other infrastructure equipment.

Paragraph 16. A method according to any of paragraphs 10 to 15, wherein the determining that the wireless transmission is to be communicated between the infrastructure equipment and the communications device in the coverage area provided by the infrastructure equipment comprises
determining that the wireless transmission overlaps in time with the indicated time and frequency resources.

Paragraph 17. A method according to any of paragraphs 1 to 16, wherein the CLI priority indicator detected from the other infrastructure equipment comprises
an indication that the CLI priority level of the other infrastructure equipment applies until further notice.

Paragraph 18. a Method According to Paragraph 17, Comprising
receiving a signal from the other infrastructure equipment indicating that the CLI priority level indicated in the CLI priority indicator no longer applies.

Paragraph 19. A method according to any of paragraphs 1 to 18, wherein the detecting the CLI priority indicator from the other infrastructure equipment comprises
receiving the CLI priority indicator from the other infrastructure equipment.

Paragraph 20. A method according to paragraph 19, wherein the receiving the CLI priority level indicator from the other infrastructure equipment comprises
receiving the CLI priority level indicator from the other infrastructure equipment in an Over The Air, OTA, transmission.

Paragraph 21. A method according to paragraph 20, wherein the CLI priority indicator comprises one or more reference signals received from the other infrastructure equipment.

Paragraph 22. A method according to paragraph 21, comprising
determining the CLI priority level of the other infrastructure equipment based on a sequence of the one or more reference signals.

Paragraph 23. A method according to paragraph 22, wherein the determining the CLI priority level of the other infrastructure equipment based on a sequence of the one or more reference signals comprises
determining a cell identification or cell group identification for the other infrastructure equipment based on the one or more reference signals, and
determining the CLI priority level of the other infrastructure equipment based on the determined cell identification or cell group identification for the other infrastructure equipment.

Paragraph 24. A method according to paragraph 21, comprising
determining the CLI priority level of the other infrastructure equipment based on a cyclic shift of the one or more reference signals.

Paragraph 25. A method according to paragraph 21, comprising
determining, based on the one or more reference signals, time and frequency resources used to transmit the one or more reference signals,
determining the CLI priority level of the other infrastructure equipment based on the time and frequency resources used to transmit the one or more reference signals.

Paragraph 26. A method according to paragraph 25, wherein the determining the CLI priority level of the other infrastructure equipment based on the time and frequency resources used to transmit the one or more reference signals comprises
determining a cell identification or cell group identification for the other infrastructure equipment based on the time and frequency resources used to transmit the one or more reference signals, and
determining the CLI priority level of the other infrastructure equipment based on the determined cell identification or cell group identification for the other infrastructure equipment.

Paragraph 27. A method according to paragraph 25, wherein the determining the CLI priority level of the other infrastructure equipment based on the time and frequency resources used to transmit the one or more reference signals comprises
identifying one or more slots or sub-slots to which the time and frequency resources used to transmit the one or more reference signals belong,
determining the CLI priority level of the other infrastructure equipment based on the identified one or more slots or sub-slots to which the time and frequency resources used to transmit the one or more reference signals belong.

Paragraph 28. A method according to paragraph 27, wherein the identifying one or more slots or sub-slots to which the time and frequency resources used to transmit the one or more reference signals belong comprises
identifying one or more OFDM symbols to which the time and frequency resources used to transmit the one or more reference signals belong,
determining the CLI priority level of the other infrastructure equipment based on the identified one or more OFDM symbols to which the time and frequency resources used to transmit the one or more reference signals belong.

Paragraph 29. A method according to any of paragraphs 21 to 28, wherein the determining the extent to which the one or more transmission parameters of the wireless transmission should be modified to reduce interference caused by the wireless transmission at the other infrastructure equipment comprises
detecting a power of the one or more reference signals,
determining that the power of the one or more reference signals exceeds a pre-defined power threshold.

Paragraph 30. A method according to any of paragraphs 20 to 29, wherein the receiving the CLI priority level indicator from the other infrastructure equipment in the OTA transmission comprises
receiving the CLI priority level indicator from the other infrastructure equipment in a physical communications channel.

Paragraph 31. A method according to paragraph 30, wherein the physical communications channel is a Physical Downlink Control Channel, PDCCH, and the method comprises
detecting the CLI priority indicator in the PDCCH by blind decoding a search space for the PDCCH.

Paragraph 32. A method according to paragraph 19, wherein the receiving the CLI priority level indicator from the other infrastructure equipment comprises
receiving the CLI priority level indicator from the other infrastructure equipment over a backhaul interface between the infrastructure equipment and the other infrastructure equipment.

Paragraph 33. A method according to any of paragraphs 1 to 32, wherein the CLI priority level of the infrastructure equipment and the other infrastructure equipment are logical channel priority levels.

Paragraph 34. A method according to any of paragraphs 1 to 33, wherein the CLI priority level of the infrastructure equipment and the other infrastructure equipment are physical layer priority levels.

### Paragraph 35. a Method According to Any of Paragraphs 1 to 34, Comprising

receiving, from the other infrastructure equipment, an updated CLI priority indicator indicating an updated CLI priority level of the other infrastructure equipment,
determining that the CLI priority level of the other infrastructure equipment is the updated CLI priority level indicated by the updated CLI priority indicator.

Paragraph 36. A method according to any of paragraphs 1 to 35, comprising transmitting a CLI priority indicator to the other infrastructure equipment indicating the CLI priority level of the infrastructure equipment.

Paragraph 37. A method according to any of paragraphs 1 to 36, wherein the detecting the CLI priority indicator from the other infrastructure equipment comprises
detecting a plurality of CLI priority indicators from a plurality of other infrastructure equipment, each of the plurality of CLI priority indicators indicating a CLI priority level of a respective one the plurality of other infrastructure equipment, wherein
the determining the extent to which the one or more transmission parameters of the wireless transmission should be modified to reduce interference at the other infrastructure equipment comprises
determining, based on a comparison of the CLI priority level of the infrastructure equipment and the plurality of CLI priority levels for the plurality of other infrastructure equipment indicated by the plurality of other CLI priority indicators, an extent to which to modify the one or more transmission parameters of the wireless transmission to reduce interference caused by the wireless transmission at the plurality of other infrastructure equipment.

Paragraph 38. A method according to paragraph 37, wherein the detecting the plurality of CLI priority indicators from the plurality of other infrastructure equipment comprises
receiving the plurality of CLI priority indicators from the plurality of other infrastructure equipment respectively.

Paragraph 39. A method according to paragraph 37 or paragraph 38, wherein each of the plurality of CLI priority indicators comprises
an indication of time and frequency resources to which the CLI priority level indicated by the CLI priority indicator applies.

Paragraph 40. A method according to paragraph 39, wherein the indication of the time and frequency resources to which the CLI priority level indicated by the CLI priority indicator applies comprises
an indication of one or more slots or sub-slots to which each to which the CLI priority level indicated by the CLI priority indicator applies.

Paragraph 41. A method according to paragraph 40, wherein the indication of the one or more slots or sub-slots to which the CLI priority level indicated by the CLI priority indicator applies comprises
an indication of one or more OFDM symbols in the one or more slots or sub-slots to which each to which the CLI priority level indicated by the CLI priority indicator applies.

Paragraph 42. A method according to any of paragraphs 1 to 41, wherein the determining the extent to which to modify the one or more transmission parameters of the wireless transmission to reduce interference caused by the wireless transmission at the other infrastructure equipment comprises
determining that the CLI priority level of the other infrastructure equipment is greater than the CLI priority level indicator for the infrastructure equipment.

Paragraph 43. A method according to any of paragraphs 1 to 42, wherein the wireless transmission is a downlink transmission.

Paragraph 44. A method of controlling cross-link interference in a wireless communications network, the method comprising
detecting, by first infrastructure equipment of the wireless communications network, a first CLI priority indicator from second infrastructure equipment of the wireless communications network, the first CLI priority indicator comprising an indication of a CLI priority level of the second infrastructure equipment,
determining, by the first infrastructure equipment, that a first wireless transmission is to be communicated between the first infrastructure equipment and a first communications device in a coverage area provided by the first infrastructure equipment,
determining, by the first infrastructure equipment based on a comparison of a CLI priority level of the first infrastructure equipment and the CLI priority level of the second infrastructure equipment indicated by the first CLI priority indicator, an extent to which one or more transmission parameters of the first wireless transmission should be modified to reduce interference caused by the first wireless transmission at the second infrastructure equipment,
modifying, by the first infrastructure equipment, the one or more transmission parameters of the first wireless transmission in accordance with the determined extent of modification of the one or more transmission parameters for the first wireless transmission,
detecting, by the second infrastructure equipment, a second CLI priority indicator from the first infrastructure equipment, the second CLI priority indicator comprising an indication of the CLI priority level of the first infrastructure equipment,
determining, by the second infrastructure equipment, that a second wireless transmission is to be communicated between the second infrastructure equipment and a second communications device in a coverage area provided by the second infrastructure equipment,
determining, by the second infrastructure equipment based on a comparison of the CLI priority level of the second infrastructure equipment and the CLI priority level of the first infrastructure equipment indicated by the second CLI priority indicator, an extent to which one or more transmission parameters of the second wireless transmission should be modified to reduce interference caused by the second wireless transmission at the first infrastructure equipment, and
modifying, by the second infrastructure equipment, the one or more transmission parameters of the second wireless transmission in accordance with the determined extent of modification of the one or more transmission parameters for the second wireless transmission.

Paragraph 45. A method of controlling cross-link interference, CLI, by a communications device in a coverage area provided by infrastructure equipment of a wireless communications network, the method comprising
determining that a wireless transmission is to be communicated between the communications device and the infrastructure equipment,
receiving, from the infrastructure equipment, an indication of an extent to which one or more transmission parameters of the wireless transmission are to be modified by the infrastructure equipment to reduce interference caused by the wireless transmission at other infrastructure equipment of the wireless communications network, the extent to which the one or more transmission parameters are to be modified by the infrastructure equipment being determined by the infrastructure equipment based on a comparison of a CLI priority level of the infrastructure equipment and a CLI priority level of the other infrastructure equipment, and communicating the wireless transmission with the infrastructure equipment in accordance with the modified one or more transmission parameters.

Paragraph 46. A method according to paragraph 45, wherein the determining that the wireless transmission is to be communicated between the communications device and the infrastructure equipment comprises
determining that a downlink transmission is to be received by the communications device from the other infrastructure equipment, wherein the receiving the indication of the extent to which the one or more transmission parameters of the wireless transmission are to be modified by the infrastructure equipment comprises
receiving an indication of an extent to which a transmission power of the downlink transmission is to be reduced and/or an indication of a modulation and coding scheme, MCS, to be used for the downlink transmission, wherein the communicating the wireless transmission with the infrastructure equipment in accordance with the modified one or more transmission parameters comprises
receiving the downlink transmission from the other infrastructure equipment according to the reduced transmission power and/or according to the indicated MCS.

Paragraph 47. A method according to paragraph 45, wherein the determining that the wireless transmission is to be communicated between the communications device and the infrastructure equipment comprises
determining that an uplink transmission is to be transmitted by the communications device to the other infrastructure equipment, wherein the receiving the indication of the extent to which the one or more transmission parameters of the wireless transmission are to be modified by the infrastructure equipment comprises
receiving an indication of an extent to which a transmission power of the uplink transmission is to be reduced and/or an indication of a modulation and coding scheme, MCS, to be used for the wireless transmission, wherein the communicating the wireless transmission with the infrastructure equipment in accordance with the modified one or more transmission parameters comprises
transmitting the uplink transmission to the other infrastructure equipment according to the reduced transmission power and/or according to the indicated MCS.

Paragraph 48. Infrastructure equipment of a wireless communications network operable to control cross-link interference, CLI, the infrastructure equipment comprising
a transmitter configured to transmit signals,
a receiver configured to receive signals, and
a controller configured in combination with the transmitter and the receiver to
detect a CLI priority indicator from other infrastructure equipment of the wireless communications network, the CLI priority indicator comprising an indication of a CLI priority level of the other infrastructure equipment,
determine that a wireless transmission is to be communicated between the infrastructure equipment and a communications device in a coverage area provided by the infrastructure equipment,
determine, based on a comparison of a CLI priority level of the infrastructure equipment and the CLI priority level of the other infrastructure equipment indicated by the CLI priority indicator, an extent to which one or more transmission parameters of the wireless transmission should be modified to reduce interference caused by the wireless transmission at the other infrastructure equipment, and
modify the one or more transmission parameters of the wireless transmission in accordance with the determined extent of modification.

Paragraph 49. Circuitry for infrastructure equipment of a wireless communications network operable to control cross-link interference, CLI, the circuitry comprising
transmitter circuitry configured to transmit signals,
receiver circuitry configured to receive signals, and
controller circuitry configured in combination with the transmitter circuitry and the receiver circuitry to
detect a CLI priority indicator from other infrastructure equipment of the wireless communications network, the CLI priority indicator comprising an indication of a CLI priority level of the other infrastructure equipment,
determine that a wireless transmission is to be communicated between the infrastructure equipment and a communications device in a coverage area provided by the infrastructure equipment,
determine, based on a comparison of a CLI priority level of the infrastructure equipment and the CLI priority level of the other infrastructure equipment indicated by the CLI priority indicator, an extent to which one or more transmission parameters of the wireless transmission should be modified to reduce interference caused by the wireless transmission at the other infrastructure equipment, and
modify the one or more transmission parameters of the wireless transmission in accordance with the determined extent of modification.

Paragraph 50. A computer program comprising instructions which, when loaded onto a computer, cause the computer to perform a method according to any of paragraphs 1 to 47.

Paragraph 51. A non-transitory computer-readable storage medium storing a computer program according to paragraph 50.

Paragraph 52. A system for controlling cross-link interference in a wireless communications network, the system comprising
first infrastructure equipment of the wireless communications network and second infrastructure equipment of the wireless communications network, the first infrastructure equipment being configured to
detect a first CLI priority indicator from the second infrastructure equipment, the first CLI priority indicator comprising an indication of a CLI priority level of the second infrastructure equipment,
determine that a first wireless transmission is to be communicated between the first infrastructure equipment and a first communications device in a coverage area provided by the first infrastructure equipment,
determine, based on a comparison of a CLI priority level of the first infrastructure equipment and the CLI priority level of the second infrastructure equipment indicated by the first CLI priority indicator, an extent to which one or more transmission parameters of the first wireless transmission should be modified to reduce interference caused by the first wireless transmission at the second infrastructure equipment,
modify the one or more transmission parameters of the first wireless transmission in accordance with the determined extent of modification of the one or more transmission parameters for the first wireless transmission, and the second infrastructure equipment being configured to
detect a second CLI priority indicator from the first infrastructure equipment, the second CLI priority indicator comprising an indication of the CLI priority level of the first infrastructure equipment,
determine that a second wireless transmission is to be communicated between the second infrastructure equipment and a second communications device in a coverage area provided by the second infrastructure equipment,
determine, based on a comparison of the CLI priority level of the second infrastructure equipment and the CLI priority level of the first infrastructure equipment indicated by the second CLI priority indicator, an extent to which one or more transmission parameters of the second wireless transmission should be modified to reduce interference caused by the second wireless transmission at the first infrastructure equipment
modify the one or more transmission parameters of the second wireless transmission in accordance with the determined extent of modification of the one or more transmission parameters for the second wireless transmission.

Paragraph 53. A communications device operable to control cross-link interference, CLI, the communications device comprising
a transmitter configured to transmit signals,
a receiver configured to receive signals, and
a controller configured in combination with the transmitter and the receiver to, when the communications device is in a coverage area provided by infrastructure equipment of the wireless communications network,
determine that a wireless transmission is to be communicated between the communications device and infrastructure equipment,
receive, from the infrastructure equipment, an indication of an extent to which one or more transmission parameters of the wireless transmission are to be modified by the infrastructure equipment to reduce interference caused by the wireless transmission at other infrastructure equipment of the wireless communications network, the extent to which the one or more transmission parameters are to be modified by the infrastructure equipment being determined by the infrastructure equipment based on a comparison of a CLI priority level of the infrastructure equipment and a CLI priority level of the other infrastructure equipment, and
communicate the wireless transmission with the infrastructure equipment in accordance with the modified one or more transmission parameters.

Paragraph 54. Circuitry for a communications device operable to control cross-link interference, CLI, the circuitry comprising
transmitter circuitry configured to transmit signals,
receiver circuitry configured to receive signals, and
controller circuitry configured in combination with the transmitter and the receiver to, when the communications device is in a coverage area provided by infrastructure equipment of the wireless communications network,
determine that a wireless transmission is to be communicated between the communications device and infrastructure equipment,
receive, from the infrastructure equipment, an indication of an extent to which one or more transmission parameters of the wireless transmission are to be modified by the infrastructure equipment to reduce interference caused by the wireless transmission at other infrastructure equipment of the wireless communications network, the extent to which the one or more transmission parameters are to be modified by the infrastructure equipment being determined by the infrastructure equipment based on a comparison of a CLI priority level of the infrastructure equipment and a CLI priority level of the other infrastructure equipment, and
communicate the wireless transmission with the infrastructure equipment in accordance with the modified one or more transmission parameters.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] RP-213591, “New SI: Study on evolution of NR duplex operation,” CMCC, RAN #94e
[3] TR38.866, “Study on remote interference management for NR (Release 16),” v16.1.0
[4] R1-2204432, “Dynamic TDD enhancements,” Nokia, Nokia Shanghai Bell, RAN1 #109e
[5] R1-1701669, “On cross-link interference mitigation for duplexing flexibility,” Huawei, HiSilicon, RAN1 #88

1. A method of controlling cross-link interference, CLI, by infrastructure equipment of a wireless communications network, the method comprising
detecting a CLI priority indicator from other infrastructure equipment of the wireless communications network, the CLI priority indicator comprising an indication of a CLI priority level of the other infrastructure equipment,
determining that a wireless transmission is to be communicated between the infrastructure equipment and a communications device in a coverage area provided by the infrastructure equipment,
determining, based on a comparison of a CLI priority level of the infrastructure equipment and the CLI priority level of the other infrastructure equipment indicated by the CLI priority indicator, an extent to which one or more transmission parameters of the wireless transmission should be modified to reduce interference caused by the wireless transmission at the other infrastructure equipment, and
modifying the one or more transmission parameters of the wireless transmission in accordance with the determined extent of modification.

2. A method according to claim 1, wherein the determining the extent to which the one or more transmission parameters of the wireless transmission should be modified to reduce interference caused by the wireless transmission at the other infrastructure equipment comprises
determining, based on the comparison of the CLI priority level of the infrastructure equipment and the CLI priority level of the other infrastructure equipment, a difference between the CLI priority level of the infrastructure equipment and the CLI priority level of the other infrastructure equipment, and
determining the extent to which the one or more transmission parameters of the wireless transmission should be modified to reduce interference caused by the wireless transmission at the other infrastructure equipment based on the determined difference, wherein
the greater the determined difference between the CLI priority level of the infrastructure equipment and the CLI priority level of the other infrastructure equipment, the greater the determined extent of modification of the one or more transmission parameters.

3. A method according to claim 1, wherein the determining the extent to which the one or more transmission parameters of the wireless transmission should be modified to reduce interference caused by the wireless transmission at the other infrastructure equipment comprises
determining an extent to which a transmission power of the wireless transmission should be reduced.

4. A method according to claim 1, wherein the CLI priority indicator comprises
an indication of time resources to which the CLI priority level of the other infrastructure equipment applies.

5. A method according to claim 4, wherein the indication of the time resources is an indication of a pre-defined time period.

6. A method according to claim 4, wherein the indicated time resources include time resources in which another wireless transmission is to be communicated between the other infrastructure equipment and another communications device in a coverage area provided by the other infrastructure equipment.

7. A method according to claim 4, wherein the determining that the wireless transmission is to be communicated between the infrastructure equipment and the communications device in the coverage area provided by the infrastructure equipment comprises
determining that the wireless transmission overlaps with the indicated time resources.

8. A method according to claim 7, wherein the determining the extent to which the one or more transmission parameters of the wireless transmission should be modified to reduce interference caused by the wireless transmission at the other infrastructure equipment comprises
determining an extent to which a start time of the wireless transmission should be delayed to reduce the overlap with the indicated time resources.

9. A method according to claim 7, wherein the determining the extent to which the one or more transmission parameters of the wireless transmission should be modified to reduce interference caused by the wireless transmission at the other infrastructure equipment comprises
determining an extent to which a transmission power of the wireless transmission should be reduced for at least the duration of the overlap with the indicated time resources.

10. A method according to claim 4, wherein the CLI priority indicator comprises
an indication of frequency resources to which the CLI priority level of the other infrastructure equipment applies.

11. A method according to claim 10, wherein the indication of the time resources and the frequency resources comprises
an indication of one or more slots or sub-slots to which the CLI priority level of the other infrastructure equipment applies.

12. (canceled)

13. A method according to claim 10, wherein the indication of the time resources and the frequency resources comprises
an indication of one or more frequency Resource Blocks, RB, one or more sets of frequency RBs or one or more sub-bands to which the CLI priority level of the other infrastructure equipment applies.

14. A method according to claim 10, wherein the indication of the time and frequency resources comprises
uplink resources for the infrastructure equipment which overlap in time and frequency with downlink resources for the other infrastructure equipment, or
downlink resources for the infrastructure equipment which overlap in time and frequency with uplink resources for the other infrastructure equipment.

15. A method according to claim 10, wherein the indicated time and frequency resources include time resources and frequency resources in which another wireless transmission is to be communicated between the other infrastructure equipment and another communications device in a coverage area provided by the other infrastructure equipment.

16. A method according to claim 10, wherein the determining that the wireless transmission is to be communicated between the infrastructure equipment and the communications device in the coverage area provided by the infrastructure equipment comprises
determining that the wireless transmission overlaps in time with the indicated time and frequency resources.

17. A method according to claim 1, wherein the CLI priority indicator detected from the other infrastructure equipment comprises
an indication that the CLI priority level of the other infrastructure equipment applies until further notice.

18.-44. (canceled)

45. A method of controlling cross-link interference, CLI, by a communications device in a coverage area provided by infrastructure equipment of a wireless communications network, the method comprising
determining that a wireless transmission is to be communicated between the communications device and the infrastructure equipment,
receiving, from the infrastructure equipment, an indication of an extent to which one or more transmission parameters of the wireless transmission are to be modified by the infrastructure equipment to reduce interference caused by the wireless transmission at other infrastructure equipment of the wireless communications network, the extent to which the one or more transmission parameters are to be modified by the infrastructure equipment being determined by the infrastructure equipment based on a comparison of a CLI priority level of the infrastructure equipment and a CLI priority level of the other infrastructure equipment, and
communicating the wireless transmission with the infrastructure equipment in accordance with the modified one or more transmission parameters.

46. A method according to claim 45, wherein the determining that the wireless transmission is to be communicated between the communications device and the infrastructure equipment comprises
determining that a downlink transmission is to be received by the communications device from the other infrastructure equipment, wherein the receiving the indication of the extent to which the one or more transmission parameters of the wireless transmission are to be modified by the infrastructure equipment comprises
receiving an indication of an extent to which a transmission power of the downlink transmission is to be reduced and/or an indication of a modulation and coding scheme, MCS, to be used for the downlink transmission, wherein the communicating the wireless transmission with the infrastructure equipment in accordance with the modified one or more transmission parameters comprises
receiving the downlink transmission from the other infrastructure equipment according to the reduced transmission power and/or according to the indicated MCS.

47. A method according to claim 45, wherein the determining that the wireless transmission is to be communicated between the communications device and the infrastructure equipment comprises
determining that an uplink transmission is to be transmitted by the communications device to the other infrastructure equipment, wherein the receiving the indication of the extent to which the one or more transmission parameters of the wireless transmission are to be modified by the infrastructure equipment comprises
receiving an indication of an extent to which a transmission power of the uplink transmission is to be reduced and/or an indication of a modulation and coding scheme, MCS, to be used for the wireless transmission, wherein the communicating the wireless transmission with the infrastructure equipment in accordance with the modified one or more transmission parameters comprises
transmitting the uplink transmission to the other infrastructure equipment according to the reduced transmission power and/or according to the indicated MCS.

48. Infrastructure equipment of a wireless communications network operable to control cross-link interference, CLI, the infrastructure equipment comprising
a transmitter configured to transmit signals,
a receiver configured to receive signals, and
a controller configured in combination with the transmitter and the receiver to
detect a CLI priority indicator from other infrastructure equipment of the wireless communications network, the CLI priority indicator comprising an indication of a CLI priority level of the other infrastructure equipment,
determine that a wireless transmission is to be communicated between the infrastructure equipment and a communications device in a coverage area provided by the infrastructure equipment,
determine, based on a comparison of a CLI priority level of the infrastructure equipment and the CLI priority level of the other infrastructure equipment indicated by the CLI priority indicator, an extent to which one or more transmission parameters of the wireless transmission should be modified to reduce interference caused by the wireless transmission at the other infrastructure equipment, and
modify the one or more transmission parameters of the wireless transmission in accordance with the determined extent of modification.

49.-54. (canceled)
